(19) United States
(12) Patent Application Publication
(10) Pub. No.: US 2007/0166683 A1
(43) Pub. Date: Jul. 19, 2007

(54) Dynamic lyrics display for portable media devices

(75) Inventors: Ray Ling Chang, San Jose, CA (US); Richard Atwell, Cupertino, CA (US)

Correspondence Address: BEYER WEAVER LLP, P.O. BOX 70250, OAKLAND, CA, 94612-0250, US

(73) Assignee: Apple Computer, Inc.

(21) Appl. No.: 11/373,468

(22) Filed: Mar. 10, 2006

Related U.S. Application Data
(60) Provisional application No. 60/756,953, filed on Jan. 5, 2006.

(51) Int. Cl. G09B 5/00

(52) U.S. Cl. 434/307 R

(57) ABSTRACT

Improved techniques for dynamically displaying text on a display screen of a portable media device while presenting media content are disclosed. The text being displayed is associated with and synchronized to the media content being presented. In one implementation, the dynamic nature of the text can scroll across the display screen of the portable media device. In another implementation, a part of the text being displayed can be distinguishably displayed from other parts. In one embodiment, the media content is music and the text is lyrics, whereby the portable media device can not only play music but also output synchronized lyrics.

### CROSS-REFERENCE TO RELATED APPLICATION

This application claims priority to U.S. Provisional Patent Application No. 60/756,953, filed Jan. 5, 2006, and entitled “DYNAMIC LYRICS DISPLAY FOR PORTABLE MEDIA DEVICES” [Att. Dkt. No.: APL1P448P], which is hereby incorporated by reference herein.

### BACKGROUND OF THE INVENTION

1. Field of the Invention

The present invention relates to portable media devices and, more particularly, to displaying text on portable media devices.

2. Description of the Related Art

Radios, stereos, CD players, MP3 players and computers are all able to play music for the benefit of their users. However, many songs that are played have complicated or difficult to understand the lyrics. Lyrics are typically available for songs that can be purchased. For example, when purchasing a CD or MP3 file, the lyrics are often provided with the purchase of the song. For example, on physical purchase of a song, the associated lyrics can be provided in the printed material provided within a CD case. As another example, on electronic purchase of a song from an online music store, the associated lyrics can be obtained as a separate electronic text file that can be acquired from the online music store. Still further, lyrics for many songs are now generally available as text files accessible from the Internet.

Specialized media devices, known as karaoke machines, facilitate the display of lyrics to a user of the karaoke machine who is attempting to sing along with the music. The karaoke machine plays a song and displays the appropriate lyrics to the user who can then read the lyrics while attempting to sing along with the associated song being played. Computers are able to play music, such as by playing audio files (e.g., MP3 files). Software programs are now available that allow a user of a personal computer to operate the personal computer such that MP3 files having embedded karaoke lyrics can cause the lyrics to be displayed on the computer screen while the song is playing. Even so, these programs require preparatory action by the user to embed (or bind) the lyrics from a lyrics file into a MP3 file.

Unfortunately, however, many users play music on small, hand-held portable media devices. Although portable media devices often include a display screen, these devices tend to be very small and do not provide for intelligent display of lyrics while playing songs. Accordingly, there is a need for improved techniques to enable users of portable media devices to view the lyrics associated with songs being played by such portable media devices.

### SUMMARY OF THE INVENTION

The invention relates to techniques for dynamically displaying text on a display screen of a portable media device while presenting media content. The text being displayed is associated with and synchronized to the media content being presented. In one implementation, the dynamic nature of the text can scroll across the display screen of the portable media device. In another implementation, a part of the text being displayed can be distinguishably displayed from other parts. The manner by which the part is distinguishably displayed can vary with implementation but can include highlighting the part through use of color, font, size, lines, dynamic effects (e.g., blinking), etc.

In one embodiment, the media content is music and the text is lyrics, whereby a portable media device can not only play music but also output synchronized lyrics. For example, when a song is played by a portable media device, lyrics associated with the song can be displayed on a display of the portable media device in a synchronized manner. From a user's perspective, the display of synchronized lyrics can be seamless and without the need for any preparatory action by the user. The invention is particularly well suited for a portable media device that is small and hand-held.

The invention can be implemented in numerous ways, including as a method, system, device, apparatus, or computer readable medium. Several embodiments of the invention are discussed below.

As a method for presenting lyrics on a display screen of a portable media device, one embodiment of the invention includes at least the acts of: identifying an audio file for a media item to be played, the identified audio file including at least audio content for the media item; retrieving an augmented lyrics file, the augmented lyrics file including the lyrics pertaining to the media item; initiating playing of audio content from the identified audio file; and dynamically displaying a portion of the lyrics from the augmented lyrics file such that the portion of the lyrics being displayed corresponds to that portion of the audio content being played.

As a method for presenting lyrics on a display screen of a portable media device, another embodiment of the invention includes at least the acts of: identifying an audio file for a media item to be played, the identified audio file including at least encoded audio content for the media item and encoded lyrics for the media item; processing the identified audio file to extract and decode the encoded audio content and the encoded lyrics; playing of the audio content from the identified audio file; and dynamically displaying a portion of the lyrics such that the portion of the lyrics being displayed corresponds to that portion of the audio content being played.

As a method for presenting lyrics on a display screen of a portable media device, still another embodiment of the invention includes at least the acts of: identifying an audio file for a media item to be played, the identified audio file including at least encoded audio content for the media item and encoded lyric codes for the media item; accessing lyrics pertaining to the media item; processing the identified audio file to extract and decode the encoded audio content and the encoded lyric codes; playing of the audio content that has been extracted and decoded from the identified audio file; displaying a portion of the lyrics such that the portion of the lyrics being displayed corresponds to that portion of the audio content being played; and distinguishably displaying, based on the lyric codes, a specific part of the portion of the lyrics being displayed from at least one other part of the lyrics being displayed.

As a method for presenting media on a display screen of a portable media device, yet still another embodiment of the invention includes at least the acts of: identifying a media item to be played by the portable media device, the media item having at least audio content and text content; outputting the audio content; and dynamically displaying a portion of the text content that corresponds to that portion of the audio content being output.

As a computer readable medium including computer program code for presenting lyrics on a display screen of a portable media device, one embodiment includes at least: computer program code for identifying an audio file for a media item to be played, the identified audio file including at least audio content for the media item; computer program code for retrieving an augmented lyrics file, the augmented lyrics file including the lyrics pertaining to the media item; computer program code for initiating playing of audio content from the identified audio file; and computer program code for dynamically displaying a portion of the lyrics from the augmented lyrics file such that the portion of the lyrics being displayed corresponds to that portion of the audio content being played.

As a portable media device having a display screen for presenting media, one embodiment of the invention includes at least: means for identifying a media item to be played by the portable media device, the media item having at least audio content and text content; means for outputting the audio content; and means for dynamically displaying a portion of the text content that corresponds to that portion of the audio content being output.

As a portable media player, one embodiment of the invention includes at least a storage device, a display device and a processor. The storage device stores at least audio content pertaining to a song, lyrics pertaining to the song, and a plurality of time codes indicating a duration of time to highlight the characters or words of the lyrics. The lyrics include a plurality of words, each of the words including at least one character. The processor controls the portable media player, including controlling playing of audio content for the song as well as displaying of the lyrics pertaining to the song on the display device in a synchronous manner with respect to the playing of the audio content.

Other aspects and advantages of the invention will become apparent from the following detailed description taken in conjunction with the accompanying drawings which illustrate, by way of example, the principles of the invention.

### BRIEF DESCRIPTION OF THE DRAWINGS

The invention will be readily understood by the following detailed description in conjunction with the accompanying drawings, wherein like reference numerals designate like structural elements, and in which:

FIG. 1 is a flow diagram of a media presentation process according to one embodiment of the invention.

FIGS. 2A-2D are representative lyric display screens according to one embodiment of the invention.

FIGS. 3A-3D illustrate a lyric display screen presenting lyrics in accordance with one embodiment of the invention.

FIG. 4 is a flow diagram of a lyrics display process according to one embodiment of the invention.

FIG. 5A is a flow diagram of a dynamic lyric display process according to one embodiment of the invention.

FIG. 5B is a representative augmented lyrics file according to one representative implementation.

FIG. 5C is a representative augmented lyrics file according to another representative implementation.

FIG. 5D is a representative augmented lyrics file according to still another representative implementation.

FIG. 6 is a flow diagram of a lyrics display process according to one embodiment of the invention.

FIG. 7 is a flow diagram of a lyrics display process according to another embodiment of the invention.

FIG. 8 is a flow diagram of a lyric file augmentation process according to one embodiment of the invention.

FIG. 9 is a block diagram of a media management system according to one embodiment of the invention.

FIG. 10 is a block diagram of a media player according to one embodiment of the invention.

### DETAILED DESCRIPTION OF THE INVENTION

The invention relates to techniques for dynamically displaying text on a display screen of a portable media device while presenting media content. The text being displayed is associated with and synchronized to the media content being presented. In one implementation, the dynamic nature of the text can scroll across the display screen of the portable media device. In another implementation, a part of the text being displayed can be distinguishably displayed from other parts. The manner by which the part is distinguishably displayed can vary with implementation but can include highlighting the part through use of color, font, size, lines, dynamic effects (e.g., blinking), etc.

In one embodiment, the media content is music and the text is lyrics, whereby a portable media device can not only play music but also output synchronized lyrics. For example, when a song is played by a portable media device, lyrics associated with the song can be displayed on a display of the portable media device in a synchronized manner. From a user's perspective, the display of synchronized lyrics can be seamless and without the need for any preparatory action by the user. The invention is particularly well suited for a portable media device that is small and hand-held.

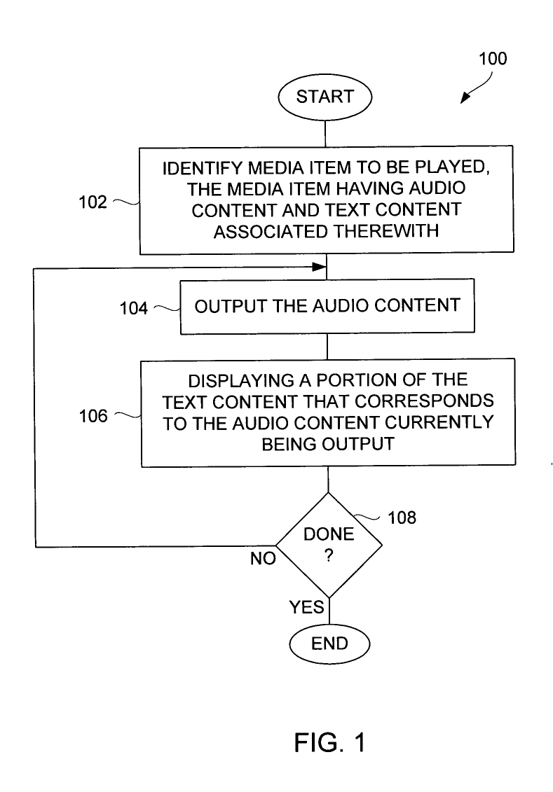

Embodiments of the invention are discussed below with reference to FIGS. 1-10. However, those skilled in the art will readily appreciate that the detailed description given herein with respect to these figures is for explanatory purposes as the invention extends beyond these limited embodiments.

FIG. 1 is a flow diagram of a media presentation process 100 according to one embodiment of the invention. The media presentation process 100 is, for example, performed by a portable media device when media is to be presented to a user.

The media presentation process initially 100 identifies 102 a media item to be played on the portable media device. In one implementation, the identification can be assisted by user interaction with a user interface of the portable media device. The identified media item has audio content as well as text content associated therewith. The audio content and the text content can be provided together or separately.

After the media item to be played has been identified 102, the audio content for the identified media item can be output 104. Here, the output 104 of the audio content causes an audio output from the portable media device. The audio output can be provided at an output jack or a speaker of the portable media device. An earphone or headset can be connected to the output jack so as to render the audio output at the earphone or headset. The audio out could alternatively be a wireless transmission of the audio data. In addition, a portion of the text content, which corresponds to the audio content currently being output, is displayed 106. As the audio content continues to be output 104, the portion of the text content that is being displayed 106 can also vary. Typically, the portion of the text content that is being displayed 106 corresponds to the particular portion of the audio content being output 104.

Next, a decision 108 determines whether the media presentation process 100 is done outputting the media item. When the decision 108 determines that the media presentation process 100 is not done outputting the media item, the media presentation process 100 returns to repeat the block 104 and subsequent blocks so that additional portions of the audio content can be output 104 and additional portions of the text content can be displayed 106. On the other hand, once the decision 108 determines that the media presentation process 100 is done, the media presentation process 100 ends.

In one embodiment, the media item can be a song and the text content can be lyrics for the song. Accordingly, a portable media device can provide media playback with synchronized lyrics.

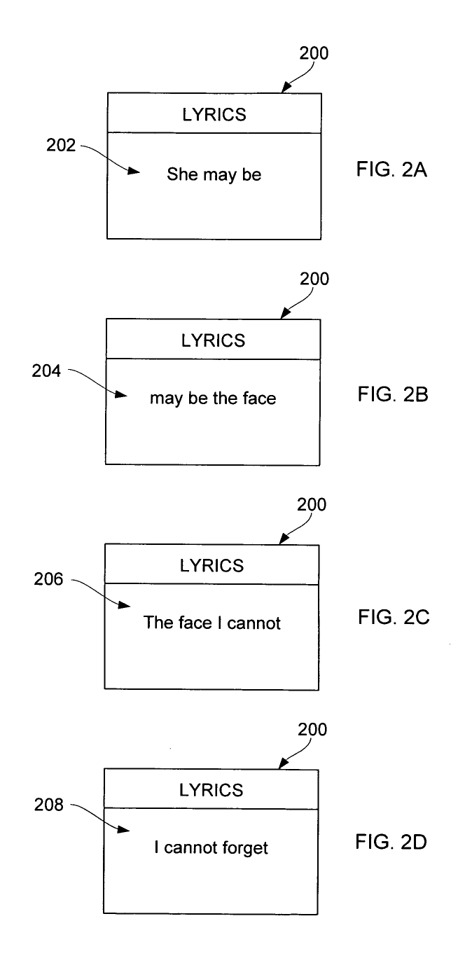

FIGS. 2A-2D are representative lyric display screens 200 according to one embodiment of the invention. The lyric display screens 200 illustrate one example of how lyrics for a song may be displayed on a display screen associated with a portable media device. Here, it should be noted that as the lyrics are being displayed, the audio content associated with the lyrics is also being output (i.e., played). In FIG. 2A, the lyric display screen 200 shows a first portion 202 of the lyrics for the media item being played. FIG. 2B illustrates the lyric display screen 200 at a subsequent point in time where a second part 204 of the lyrics corresponding to the media item is being displayed. The second part 204 can follow the first part 202 directly, or there can be other intermediate parts or different transitions between the first part 202 and the second part 204. A portion of the second part 204 can also be the same as a portion of the first part 202. For example, in this example, the lyrics are displayed on the lyric display screen 200 in a single line or row. The lyrics can be displayed in a scrolling manner, such as scrolling left-to-right. The scrolling can be character by character, word by word or phrase by phrase. The second part 204 can be considered to be scrolled from the first part 202 where one word “She” has scrolled off the lyric display screen 200 and two words “the face” have scrolled onto the lyric display screen 200. FIG. 2C illustrates the lyric display screen 200 with a third part 206 of the lyrics being displayed. The third part 206 can follow the second part 204 directly, or there can be other intermediate parts or different transitions between the first part 202 and the second part 204. A portion of the third part 206 can also be the same as a portion of the second part 204. The third part 206 can be considered to be scrolled from the second part 204 where two words “may be” have scrolled off the lyric display screen 200 and two words “I cannot” have scrolled onto the lyric display screen 200. FIG. 2D illustrates the lyric display screen 200 displaying a fourth part 208 of the lyrics. Note that the fourth part 208 can be considered scrolled from the third part 206 where two words “the face” have scrolled off the lyric display screen 200 and one word “forget” has scrolled onto the lyric display screen 200.

Beyond displaying the lyrics such that they correspond to the audio output, a specific part of the displayed portion of the lyrics can be distinguishably displayed from the other parts being displayed. This display technique can be referred to as a karaoke display mode. By distinguishably displaying a portion of the lyrics being displayed, a user of the portable media device can be informed as to the particular word/syllable of the song being sung. This distinguishably displaying is particularly helpful for those users that desire to sing alone with the song being played. The manner by which the part is distinguishably displayed can vary with implementation but can include highlighting through use of color, font, size, lines, dynamic effects (e.g., blinking), etc.

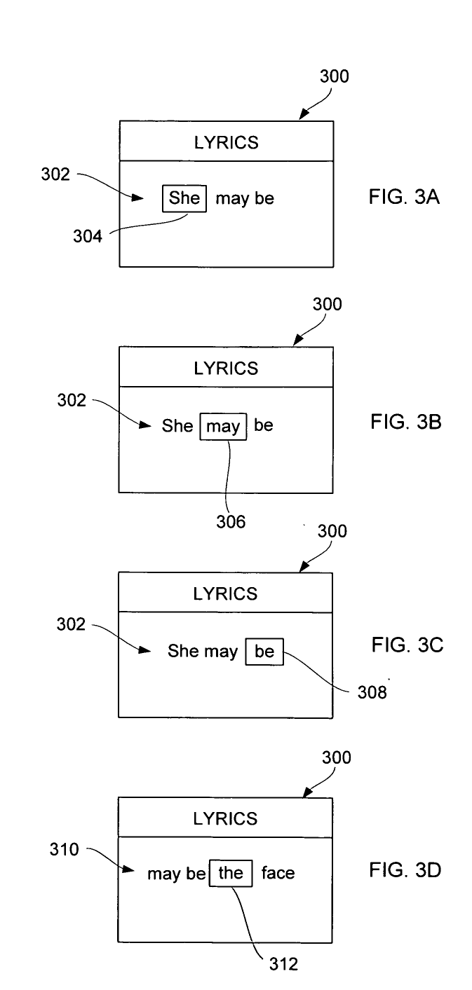

FIGS. 3A-3D illustrate a lyric display screen 300 presenting lyrics in accordance with one embodiment of the invention. FIG. 3A illustrates the lyric display screen 300 depicting a first part 302 of the lyrics with a first portion (e.g., first word) of the first part 302 being highlighted by use of an outline box 304. FIG. 3B illustrates the lyric display screen 300 at a subsequent point in time in which an outline box 306 surrounds a second portion (e.g., second word) of the first part 302 of the lyrics. FIG. 3C illustrates the lyric display screen 300 at a subsequent point in time in which an outline box 308 surrounds a third portion (e.g., third word) of the first part 302 of the lyrics. FIG. 3D illustrates the lyric display screen 300 having a second part 310 of the lyrics being displayed therein. The second part 310 of the lyrics overlaps with the first part 302 of the lyrics. In other words, the second part 310 of the lyrics can represent a scrolled version of the first part 302 after having scrolled one word. In any case, as shown in FIG. 3D, an outline box 312 surrounds another portion of the second part 310 of the lyrics.

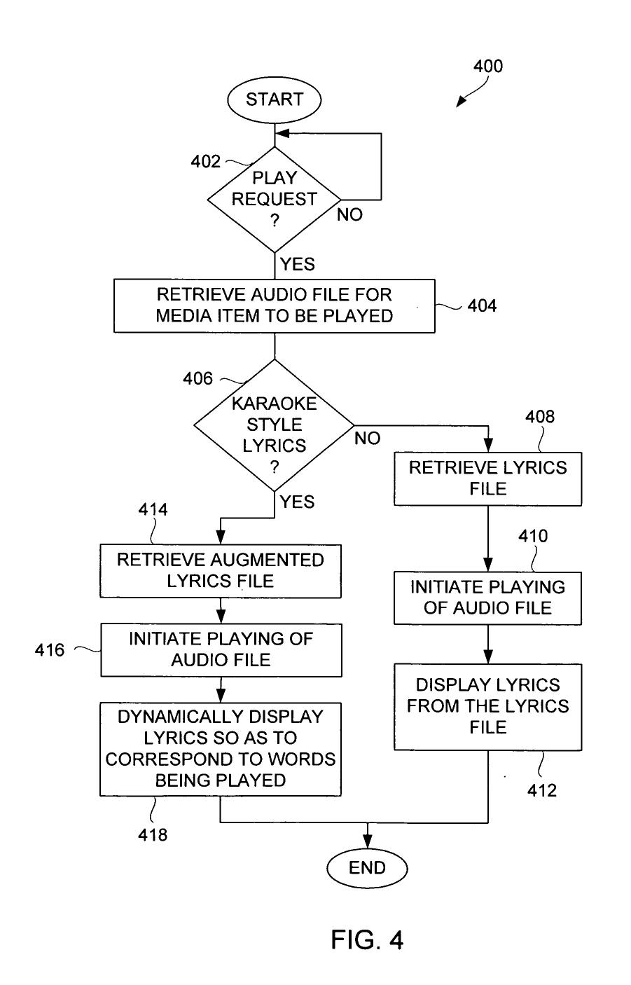

FIG. 4 is a flow diagram of a lyrics display process 400 according to one embodiment of the invention. The lyrics display process 400 is, for example, performed by a portable media device.

The lyrics display process 400 begins with a decision 402. The decision 402 determines whether a play request for a particular audio file has been made. When the decision 402 determines that a play request has not yet been made, the lyrics display process 400 awaits such a request. In other words, the lyrics display process 400 can be invoked in response to a play request. Once the decision 402 determines that a play request has been received, an audio file for the media item to be played is retrieved 404.

Next, a decision 406 determines whether karaoke style lyrics are to be utilized. Whether or not karaoke style lyrics are to be utilized can be determined by a user of the portable media device. For example, the user can interact with the portable media device to make a selection or provide user input to signal the portable media device that karaoke style lyrics are to be utilized. The portable media device can also be configured, by the user or another, to set a preference or user setting to cause karaoke style lyrics to be utilized. Hence, when the decision 406 determines that karaoke style lyrics are not to be utilized, then the lyrics file associated with the audio file to be played is retrieved 408. Then, the playing of the audio file is initiated 410. Initiating of the playing of the audio starts the playback (i.e., audio output) of the audio file. For example, the audio file can pertain to a song. In addition, lyrics from the lyrics file associated with the audio file are displayed 412. Accordingly, as the audio file is being played, the appropriate lyrics can be displayed 412.

Alternatively, when the decision 406 determines that karaoke style lyrics are to be utilized, an augmented lyrics file is retrieved 414. Then, playing of the audio file is initiated 416. Initiating of the playing of the audio starts the playback (i.e., audio output) of the audio file. For example, the audio file can pertain to a song. Once the playing of the audio file has been initiated 416, lyrics corresponding to the audio output are dynamically displayed 418. For example, the dynamic display 418 of the lyrics is performed so as to correspond to the words of a song being played. Following the blocks 412 and 418, the lyrics display process 400 is complete and ends.

In another embodiment, a lyrics display process could be invoked without playing the associated audio content for a media item. For example, instead of a play request, a user might request to have the lyrics displayed (without also playing the audio content). In such case, in response to the user request, the block of 408-412 of the lyrics display process 400 could be performed to display the lyrics for the benefit of the user.

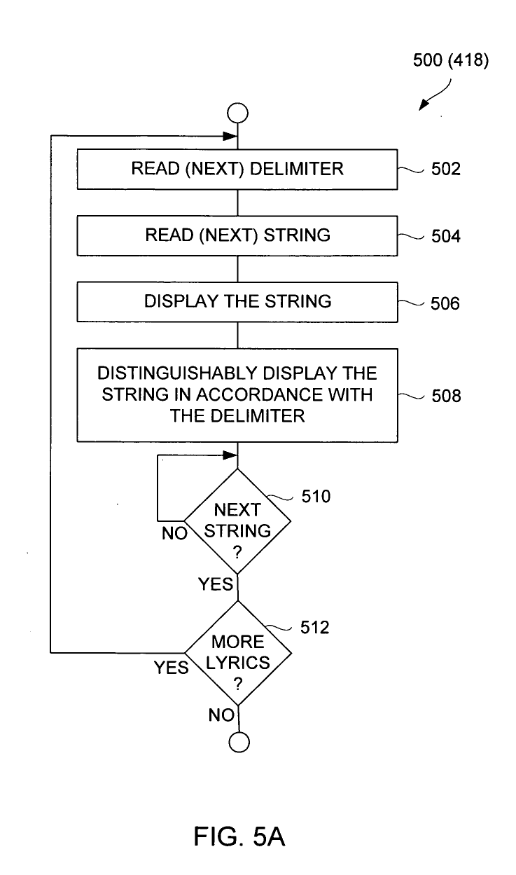

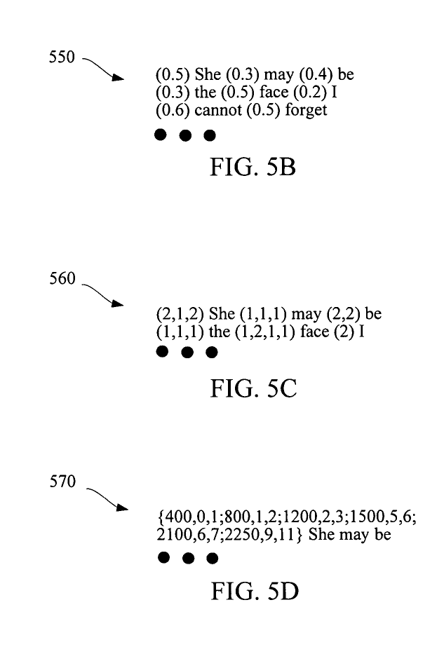

FIG. 5A is a flow diagram of a dynamic lyric display process 500 according to one embodiment of the invention. The dynamic lyric display process 500 is, for example, suitable for use as the processing associated with the block 418 illustrated in FIG. 4 so as to dynamically display lyrics.

The dynamic lyric display process 500 operates to process an augmented lyrics file to obtain delimiters (or time codes) as well as strings of characters corresponding to the lyrics. Hence, the dynamic lyric display process 500 initially reads 502 a delimiter from the augmented lyrics file. In addition, a string is read 504 from the lyrics file. The string is typically one or a plurality of characters, which represent one or more words or phrases. The string can be displayed 506 on a display screen associated with the portable media device. The manner in which the string is displayed can involve a static display, a scrolling display (either vertically or horizontally), a fade in/out, etc. Further, the string is distinguishably displayed 508 in accordance with the delimiter. For example, the delimiter can indicate a duration of time for the string, or some portion thereof, to be distinguishably displayed 508. In one example, the part of the string to be distinguishably displayed can be highlighted by way of color, lines, font, arrows, markers, etc. as well as any combinations thereof. Typically, the part of the string being distinguishably displayed 508 remains distinguishably displayed for the duration of time associated with the delimiter. A decision 510 determines whether the string or its distinguishably displayed portion should be updated. When the decision 510 determines that a next string is to be displayed, a decision 512 determines whether more lyrics are to be processed. When the decision 512 determines that more lyrics are to be processed, the dynamic lyric display process 500 returns to repeat the block 502 and subsequent blocks so that additional portions of the augmented lyrics file can be similarly processed.

FIG. 5B is a representative augmented lyrics file 550 according to one representative implementation. As shown in FIG. 5B, prior to each word of the lyrics, is a delimiter value. In this example, the delimiter value corresponds to the subsequent word and indicates the duration of time (e.g., in seconds) that the subsequent word should be highlighted when being displayed. Hence, the delimiters signal how long the corresponding parts of the lyrics should be highlighted. In addition, taking together the durations of time associated with the various delimiters causes the display of the lyrics to remain synchronized with the outputting of the audio content.

FIG. 5C is a representative augmented lyrics file 560 according to another representative implementation. As shown in FIG. 5C, prior to each word of the lyrics, is one or more delimiter values. In this example, each of the delimiter values corresponds to one character of the subsequent word and indicates the duration of time (e.g., in seconds) that the corresponding character in the subsequent word should be highlighted when being displayed. Hence, the delimiters signal how long the corresponding parts of the lyrics should be highlighted. In addition, taking together the durations of time associated with the various delimiters causes the display of the lyrics to remain synchronized with the outputting of the audio content.

FIG. 5D is a representative augmented lyrics file 570 according to still another representative implementation. As shown in FIG. 5D, prior to a series of words of the lyrics, is a number of tuplets. Each tuplet specifies three numbers, the first number specifies a duration of time (in time units) to highlight, and the second and third numbers specify a range of characters in the phrase to be highlighted. For example, one time unit can equal 1.67 ms. Hence, the tuplets signal how long the corresponding parts of the lyrics should be highlighted. For the example shown in FIG. 5D, the phrase “She may be” is displayed, then the “S” character of “She” is highlighted for 400 time units, the “h” character of “She” is highlighted for 800 time units, “e” character of “She” is highlighted for 1200 time units, etc. The durations of time associated with the various tuplets causes the display of the lyrics to remain synchronized with the outputting of the audio content.

Regardless of the implementation of highlighting parts or portions of the lyrics (of which there are many approaches that can be used), earlier highlighted parts or portions can either remain highlighted or be subsequently de-highlighted. Pauses between words could also be specifically denoted with time durations. Other audible effects (tones, accents, etc.) could also be denoted and affect the manner that the lyrics are displayed.

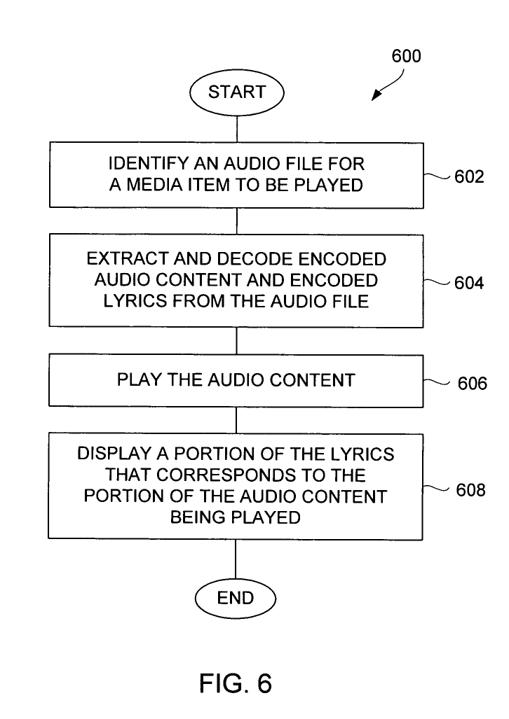

FIG. 6 is a flow diagram of a lyrics display process 600 according to one embodiment of the invention. The lyrics display process 600 is, for example, performed by a portable media device.

The lyrics display process 600 initially identifies 602 an audio file for a media item to be played. In this embodiment, the audio file includes at least encoded audio content and encoded lyrics for the audio content. After the audio file has been identified 602, and assuming that the audio file is to be output (i.e., played), the lyrics display process 600 extracts and decodes 604 the encoded audio content and the encoded lyrics from the audio file. Next, the audio content is played 606. While the audio content is being played 606, a portion of the lyrics that corresponds to the portion of audio content being played is displayed 608. That is, the portion of the lyrics being displayed 608 is frequently updated so as to remain synchronized with the audio content being played 606. Following the block 608, assuming that the audio content has been completely played 606 and the lyrics corresponding thereto have been completely displayed, the lyrics display process 600 is complete and ends.

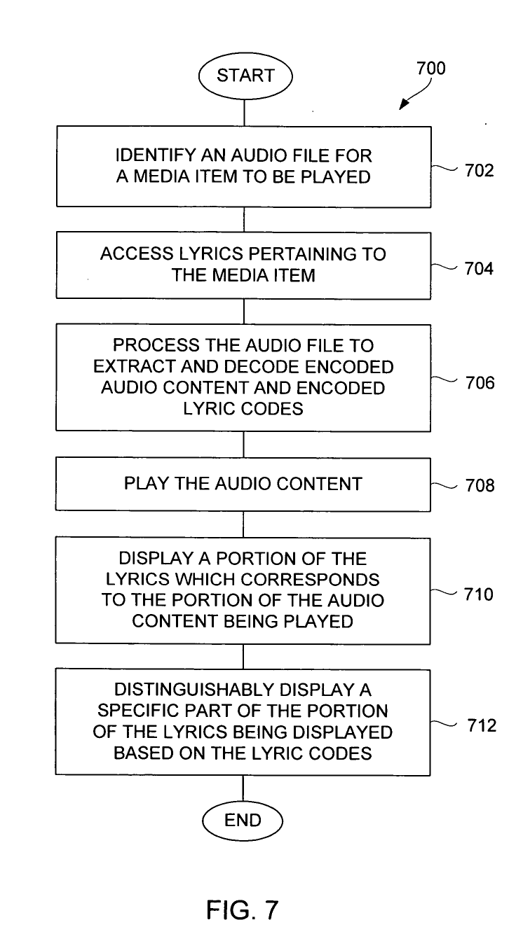

FIG. 7 is a flow diagram of a lyrics display process 700 according to another embodiment of the invention. The lyrics display process 700 is, for example, performed by a portable media device.

The lyrics display process 700 initially identifies 702 an audio file for a media item to be played. In addition, lyrics pertaining to the media item are accessed 704. The audio file is then processed 706 to extract and decode encoded audio content and encoded lyric codes which are contained within the audio file. Thereafter, the audio content can be played 708 at the portable media device. In addition, while the audio content is being played 708 an appropriate portion of the lyrics can be displayed 710. In other words, while the audio content is being played, the portion of the lyrics that is displayed 710 corresponds to the portion of the audio content being played. In other words, the lyrics being displayed are synchronized with the audio content being played.

In addition, a specific part of the portion of the lyrics being displayed 710 can be distinguishably displayed 712. More particularly, based on the lyric codes, a specific part of the portion of the lyrics being displayed can be distinguished from other parts of the portion of the lyrics being displayed. As discussed above with regard to FIGS. 3A-3D, the distinguishably displaying of a specific part of the displayed lyrics can be done in a variety of different ways. Following the block 712, the lyrics display process 700 is complete and ends.

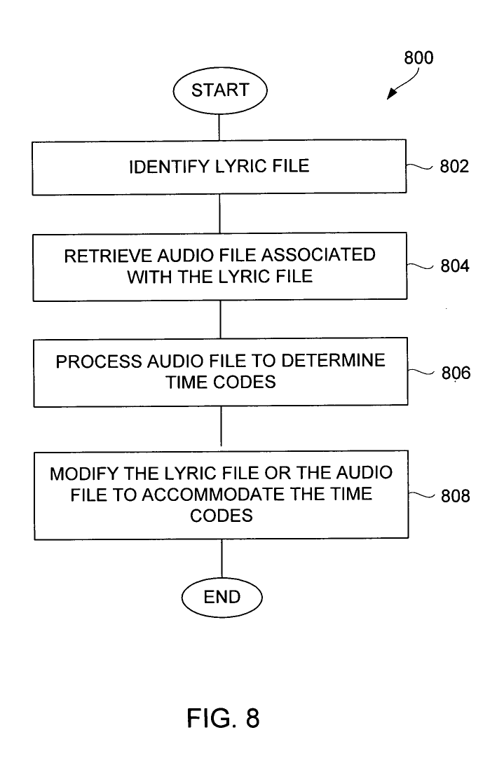

FIG. 8 is a flow diagram of a lyric file augmentation process 800 according to one embodiment of the invention. The lyric file augmentation process 800 operates to augment a lyric file to include time codes (or delimiters) that are used to assist with the ability to have the appropriate lyrics being displayed while corresponding audio content is being output. The lyric file augmentation process 800 can be performed automatically by a computing device.

The lyric file augmentation process 800 identifies 802 a lyric file. Then, an audio file associated with the lyric file is retrieved 804. Then, the audio file can be processed 806 to determine time codes. Here, using speech recognition or signal processing techniques, time codes association with the audio file can be determined. In one embodiment, the audio file can be analyzed to locate pause periods between words or phrases and then assign time codes. In another embodiment, through speech recognition, the computing device can recognize “She” in the song, and then can assign one or more time codes (e.g., start time and duration to highlight). As another embodiment, again through speech recognition, the computing device can recognize “Forget” as a two-syllable word and can assign one or more time codes (e.g., timestamp and duration for each syllable). The lyric file or the audio file can then be modified 808 to accommodate the time codes. In one embodiment, the lyric file is augmented to include the time codes. In another embodiment, the audio file can be modified to accommodate the time codes. Following the block 808, the lyric file augmentation process 800 ends.

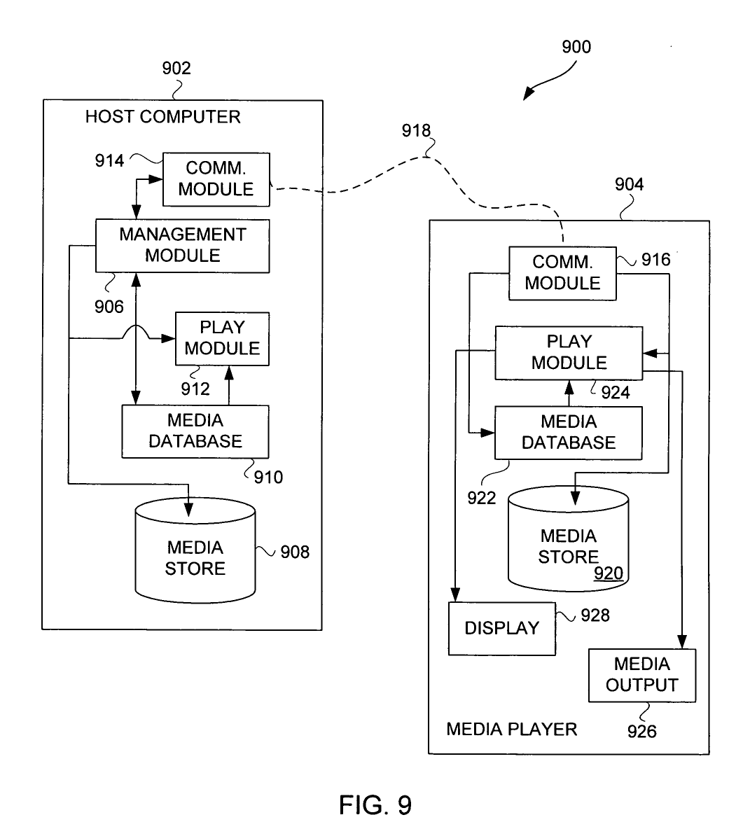

FIG. 9 is a block diagram of a media management system 900 according to one embodiment of the invention. The media management system 900 includes a host computer 902 (or media host device) and a media player 904 (or portable media device).

The term “media player” generally refers to computing devices that are capable of, often primarily dedicated to, processing media such as audio, video or images. The media players are generally portable so as to allow a user to listen to music, play games, etc. wherever the user travels. In one embodiment, the media player is a hand-held device that is sized for placement into a pocket of the user (i.e., pocket-sized) or sized to fit in the palm of the user's hand. Furthermore, the device may be operated by the user's hands, no reference surface such as a desktop is needed. In one implementation, the music player can be pocket-sized and rather lightweight for true portability.

The host computer 902 is typically a personal computer. The host computer 902, among other conventional components, includes a management module 906 which is a software module. The management module 906 provides for centralized management of media items (and/or playlists) not only on the host computer 902 but also optionally on the media player 904. More particularly, the management module 906 manages those media items stored in a media store 908 associated with the host computer 902. The management module 906 also interacts with a media database 910 to store media information associated with the media items stored in the media store 908.

Each media item includes media content and may also include text content. The text content is typically associated with the media content. For example, the media content can be audio content for a song and the text content can be lyrics for the song. The media content and the associated text content can be provided in the same electronic file or separate electronic files.

The media information pertains to characteristics or attributes of the media items. For example, in the case of audio or audiovisual media, the media information can include one or more of: title, album, track, artist, composer and genre. These types of media information are specific to particular media items. The media information can also indicate one or more of: time purchased, time downloaded, how often played, rating, etc. In addition, the media information can pertain to quality characteristics of the media items. Examples of quality characteristics of media items can include one or more of: bit rate, sample rate, equalizer setting, volume adjustment, start/stop and total time.

Still further, the host computer 902 includes a play module 912. The play module 912 is a software module that can be utilized to play certain media items stored in the media store 908. The play module 912 can also display (on a display screen) or otherwise utilize media information from the media database 910. Typically, the media information of interest corresponds to the media items to be played by the play module 912.

The host computer 902 also includes a communication module 914 that couples to a corresponding communication module 916 within the media player 904. A connection 918 can couple the communication modules 914 and 916. The connection 918 can be through a peripheral cable (e.g., USB cable or FIREWIRE cable) or through one or more networks (wired or wireless) that can be coupled to the communication modules 914 and 916. Hence, even when the media player 904 is remotely located from the host computer 902, communication between the devices is possible over the one or more networks.

The media player 904 also includes a media store 920 that stores media items within the media player 904. Again, each media item includes media content and may also include text content. The media items being stored to the media store 920 can be received over the connection 918 from the host computer 902. More particularly, the management module 906 sends all or certain of those media items residing on the media store 908 over the connection 918 to the media store 920 within the media player 904. Additionally, the corresponding media information for the media items that is also delivered to the media player 904 from the host computer 902 can be stored in a media database 922. In this regard, certain media information from the media database 910 within the host computer 902 can be sent to the media database 922 within the media player 904 over the connection 918. Still further, playlists identifying certain of the media items can also be sent by the management module 906 over the network connection 918 to the media store 920 or the media database 922 within the media player 904.

Furthermore, the media player 904 includes a play module 924 that couples to the media store 920 and the media database 922. The play module 924 is a software module that can be utilized to play certain media items stored in the media store 920. The play module 924 can also display (on a display screen) or otherwise utilize media information from the media database 922. Typically, the media information of interest corresponds to the media items to be played by the play module 924. When a media item is played at the media player 904, the play module can access and output media content (e.g., audio or video content) to a media output 926. The media output 926 can, for example, pertain to a speaker or a speaker jack (which permits connection to an external speaker) for audio output, or a connector for video output. While the media content is being output, the play module 924 (or other module) can also cause the text content (e.g., lyrics) associated with the media item to be displayed on a display 928. Although the media content being output by the media player 904 can be stored as a file in the media store 920, the media content could alternatively be output by being streamed from the host computer 902 to the media player 904.

In one embodiment, the host computer 902 can connect to a media store server (not shown) via a network. The media store server provides an online commerce center for access to digital data, namely, media items. By interacting with the media store server, the host computer 902 (or its user) can browse, preview, play or purchase media items. Additional details on an online commerce center are provided in U.S. Patent Publication 2005/0021478 A1, which is hereby incorporated herein by reference.

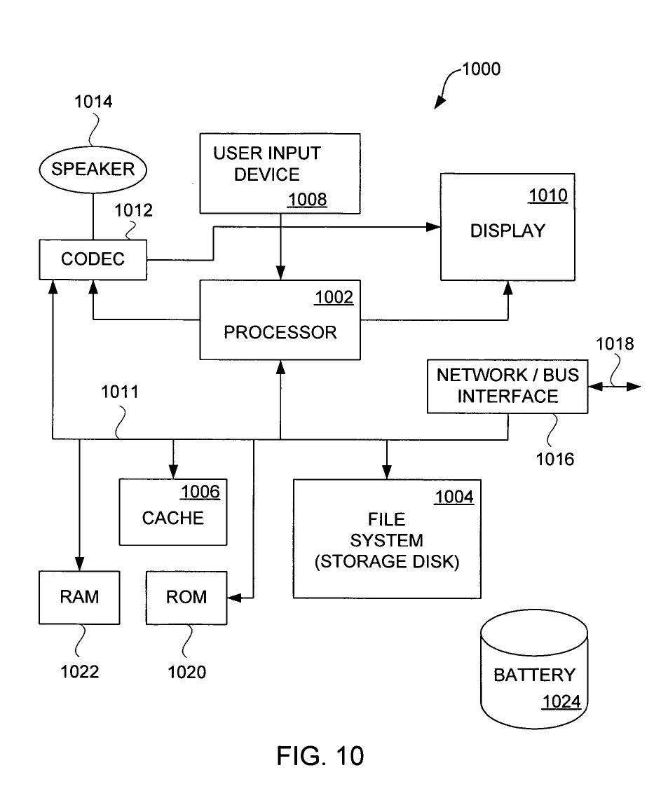

FIG. 10 is a block diagram of a media player 1000 according to one embodiment of the invention. The media player 1000 includes a processor 1002 that pertains to a microprocessor or controller for controlling the overall operation of the media player 1000. The media player 1000 stores media data pertaining to media items in a file system 1004. More particularly, media files for the media items are stored in the file system 104. The file system 1004 is, typically, a storage disk or a plurality of disks. The file system 1004 typically provides high capacity storage capability for the media player 1000. The file system 104 can store not only media data but also non-media data (e.g., when operated in a disk mode). However, since the access time to the file system 1004 is relatively slow, the media player 1000 can also include a cache 1006 (cache memory). The cache 1006 is, for example, Random-Access Memory (RAM) provided by semiconductor memory. The relative access time to the cache 1006 is substantially shorter than for the file system 1004. However, the cache 1006 does not have the large storage capacity of the file system 1004. Further, the file system 1004, when active, consumes more power than does the cache 1006. The power consumption is often a concern when the media player 1000 is a portable media player that is powered by a battery (not shown). The media player 1000 also includes a RAM 1020 and a Read-Only Memory (ROM) 1022. The ROM 1022 can store programs, utilities or processes to be executed in a non-volatile manner. The RAM 1020 provides volatile data storage, such as for the cache 1006. Still further, the media player 1000 is a portable device and is, therefore, often powered by a battery 1024.

The media player 1000 also includes a user input device 1008 that allows a user of the media player 1000 to interact with the media player 1000. For example, the user input device 1008 can take a variety of forms, such as a button, keypad, dial, etc. Still further, the media player 1000 includes a display 1010 (screen display) that can be controlled by the processor 1002 to display information to the user. A data bus 1011 can facilitate data transfer between at least the file system 1004, the cache 1006, the processor 1002, and the CODEC 1012.

In one embodiment, the media player 1000 serves to store a plurality of media items (e.g., songs or video) in the file system 1004. When a user desires to have the media player play a particular media item, a list of available media items is displayed on the display 1010. Then, using the user input device 1008, a user can select one of the available media items. Upon receiving a selection of a particular media item, the media data (e.g., audio file) for the particular media item can be accessed by the processor 1002 and then supplied to a coder/decoder (CODEC) 1012. In the case of video and audio output, the CODEC 112 produces video output signals for the display 1010 (or a display driver) and produces analog output signals for a speaker 1014 (in this case the CODEC 1012 can include one CODEC for audio and another CODEC for video). The speaker 1014 can be a speaker internal to the media player 1000 or external to the media player 1000. For example, headphones or earphones that connect to the media player 1000 would be considered an external speaker.

The media player 1000 also includes a network/bus interface 1016 that couples to a data link 1018. The data link 1018 allows the media player 1000 to couple to a network. The data link 1018 can be provided over a wired connection or a wireless connection. In the case of a wireless connection, the network/bus interface 1016 can include a wireless transceiver. In one embodiment, the data link 1018 allows the media player 1000 to couple to a peripheral bus (e.g., via a cable). The peripheral bus can facilitate not only data transfer but also supply power to the media player 1000.

In another embodiment, a media player can be used with a docking station. The docking station can provide wireless communication capability (e.g., wireless transceiver) for the media player, such that the media player can communicate with a host device using the wireless communication capability when docked at the docking station. The docking station may or may not be itself portable.

In yet another embodiment, a larger portable device, such as a vehicle, bag or case, can house or contain the portable media device and also optionally provide the network access.

The media items of emphasis in several of the above embodiments can be audio items (e.g., audio files or songs, audiobooks, and/or podcasts), videos (e.g., movies) or images (e.g., photos). The media items can also be multimedia items.

The various aspects, embodiments, implementations or features of the invention can be used separately or in any combination.

The invention is preferably implemented by software, but can also be implemented in hardware or a combination of hardware and software. The invention can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, optical data storage devices, and carrier waves. The computer readable medium can also be distributed over network-coupled computer systems so that the computer readable code is stored and executed in a distributed fashion.

The advantages of the invention are numerous. Different aspects, embodiments or implementations may yield one or more of the following advantages. One advantage of the invention is that a portable media device is able to display lyrics of an associated audio item (e.g., song) in a manner that is synchronized with audio output of the audio item that is being played. As a result, a user of the portable media device can not only hear the audio output for the audio item (e.g., song) but can also see the corresponding lyrics being displayed. The display of the lyrics synchronized with the audio output assists the user in understanding the lyrics. Another advantage of the invention is that a particular part or portion of the lyrics can be distinguished from other parts or portions so as to further guide the user with respect to the associated audio output. Such additional guidance can be useful for users seeking to understand the song's lyrics or how to sing the song.

The many features and advantages of the present invention are apparent from the written description and, thus, it is intended by the appended claims to cover all such features and advantages of the invention. Further, since numerous modifications and changes will readily occur to those skilled in the art, the invention should not be limited to the exact construction and operation as illustrated and described. Hence, all suitable modifications and equivalents may be resorted to as falling within the scope of the invention.

What is claimed is:

1. A method for presenting lyrics on a display screen of a portable media device, said method comprising:
(a) identifying an audio file for a media item to be played, the identified audio file including at least audio content for the media item;
(b) retrieving an augmented lyrics file, the augmented lyrics file including the lyrics pertaining to the media item;
(c) initiating playing of audio content from the identified audio file; and
(d) dynamically displaying a portion of the lyrics from the augmented lyrics file such that the portion of the lyrics being displayed corresponds to that portion of the audio content being played.

2. A method as recited in claim 1, wherein the augmented lyrics file further includes a plurality of time codes.

3. A method as recited in claim 2, wherein said dynamically displaying (d) uses the time codes from the augmented lyrics file to synchronize the portion of the lyrics being displayed with that portion of the audio content being played.

4. A method as recited in claim 3, wherein the time codes are provided on a per phrase, per word or per character basis.

5. A method as recited in claim 1, wherein said dynamically displaying (d) distinguishably displays a specific part of the portion of the lyrics being displayed.

6. A method as recited in claim 5, wherein the specific part of the portion of the lyrics being distinguishably displayed is synchronized with that portion of the audio content being played.

7. A method as recited in claim 6,
wherein the augmented lyrics file further includes a plurality of time codes, and
wherein said dynamically displaying (d) uses the time codes from the augmented lyrics file to distinguishably display the specific part of the portion of the lyrics being displayed.

8. A method as recited in claim 7, wherein the specific part of the portion of the lyrics being distinguishably displayed is displayed in a highlighted manner.

9. A method as recited in claim 1, wherein said dynamically displaying (d) automatically scrolls the lyrics being displayed.

10. A method as recited in claim 1, wherein the portable media device is a hand-held media player.

11. A method as recited in claim 10, wherein the media item is a song.

12. A method for presenting lyrics on a display screen of a portable media device, said method comprising:
(a) identifying an audio file for a media item to be played, the identified audio file including at least encoded audio content for the media item and encoded lyrics for the media item;
(b) processing the identified audio file to extract and decode the encoded audio content and the encoded lyrics;
(c) playing of the audio content from the identified audio file; and
(d) dynamically displaying a portion of the lyrics such that the portion of the lyrics being displayed corresponds to that portion of the audio content being played.

13. A method as recited in claim 12, wherein said processing (b), said playing (c) and said displaying (d) are performed concurrently.

14. A method as recited in claim 12, wherein said dynamically displaying (d) distinguishably displays a specific part of the portion of the lyrics being displayed.

15. A method as recited in claim 14, wherein the specific part of the portion of the lyrics being distinguishably displayed is synchronized with that portion of the audio content being played.

16. A method as recited in claim 15, wherein said processing (b), said playing (c) and said displaying (d) are performed concurrently.

17. A method as recited in claim 14, wherein said dynamically displaying (d) automatically scrolls the lyrics being displayed.

18. A method for presenting lyrics on a display screen of a portable media device, said method comprising:
(a) identifying an audio file for a media item to be played, the identified audio file including at least encoded audio content for the media item and encoded lyric codes for the media item;
(b) accessing lyrics pertaining to the media item;
(c) processing the identified audio file to extract and decode the encoded audio content and the encoded lyric codes;
(d) playing of the audio content that has been extracted and decoded from the identified audio file;
(e) displaying a portion of the lyrics such that the portion of the lyrics being displayed corresponds to that portion of the audio content being played; and
(f) distinguishably displaying, based on the lyric codes, a specific part of the portion of the lyrics being displayed from at least one other part of the lyrics being displayed.

19. A method as recited in claim 18, wherein the specific part of the portion of the lyrics being distinguishably displayed is synchronized with that portion of the audio content being played.

20. A method as recited in claim 19, wherein the specific part of the portion of the lyrics being distinguishably displayed is displayed in a highlighted manner.

21. A method as recited in claim 18, wherein said accessing (b) operates to access the lyrics from a header of the audio file.

22. A method as recited in claim 18, wherein said accessing (b) operates to access the lyrics from a separate lyrics file.

23. A method as recited in claim 18, wherein said dynamically displaying (f) automatically scrolls the lyrics being displayed.

24. A method for presenting media on a display screen of a portable media device, said method comprising:
(a) identifying a media item to be played by the portable media device, the media item having at least audio content and text content;
(b) outputting the audio content; and
(c) dynamically displaying a portion of the text content that corresponds to that portion of the audio content being output.

25. A method as recited in claim 24, wherein said outputting (b) is streaming the audio content to an output device.

26. A method as recited in claim 24, wherein the output device is an internal or external speaker with respect to the portable media device.

27. A computer readable medium including computer program code for presenting lyrics on a display screen of a portable media device, said computer readable medium comprising:
computer program code for identifying an audio file for a media item to be played, the identified audio file including at least audio content for the media item;
computer program code for retrieving an augmented lyrics file, the augmented lyrics file including the lyrics pertaining to the media item;
computer program code for initiating playing of audio content from the identified audio file; and
computer program code for dynamically displaying a portion of the lyrics from the augmented lyrics file such that the portion of the lyrics being displayed corresponds to that portion of the audio content being played.

28. A computer readable medium including computer program code for determining time codes suitable for use in presenting lyrics on a display screen of a computing device, said computer readable medium comprising:
computer program code for identifying a lyric file, the lyric file being associated with an audio file for a media item, the audio file including at least audio content for the media item;
computer program code for retrieving the audio file associated with the lyric file;
computer program code for processing the audio file to determine time codes; and
computer program code for modifying the lyric file or the audio file to accommodate the time codes.

29. A portable media device having a display screen for presenting media, said device comprising:
means for identifying a media item to be played by the portable media device, the media item having at least audio content and text content;
means for outputting the audio content; and
means for dynamically displaying a portion of the text content that corresponds to that portion of the audio content being output.

30. A portable media player, comprising:
a storage device, said storage device storing at least audio content pertaining to a song;
lyrics pertaining to the song, the lyrics including a plurality of words, each of the words including at least one character; and
a plurality of time codes indicating a duration of time to highlight the characters or words of the lyrics;
a display device; and
a processor for controlling said portable media player, including controlling playing of audio content for the song as well as displaying of the lyrics pertaining to the song on said display device in a synchronous manner with respect to the playing of the audio content.

31. A portable media player as recited in claim 30, wherein the lyrics are displayed on said display device in a scrolling manner.
